(19) United States
(12) Patent Application Publication
(10) Pub. No.: US 2007/0171981 A1
(43) Pub. Date: Jul. 26, 2007

(54) Projection based techniques and apparatus that generate motion vectors used for video stabilization and encoding

(76) Inventor: Yingyong Qi, San Diego, CA (US)

Correspondence Address: QUALCOMM INCORPORATED, 5775 MOREHOUSE DR., SAN DIEGO, CA, 92121, US

(21) Appl. No.: 11/340,320

(22) Filed: Jan. 25, 2006

(51) Int. Cl. H04N 11/04; H04B 1/66

(52) U.S. Cl. 375/240.24; 375/240.27

(57) ABSTRACT

In a video system a method and/or apparatus to process video blocks comprising: the generation of at least one set of projections for a video block in a first frame, and the generation of at least one set of projections for a video block in a second frame, The at least one set of projections from the first frame are compared to the at least one set of projections from the second frame. The result of the comparison produces at least one projection correlation error (PCE) value.

### TECHNICAL FIELD

What is described herein relates to digital video processing and, more particularly, projection based techniques that generate motion vectors used for video stabilization and video encoding.

### BACKGROUND

Digital video capabilities can be incorporated into a wide range of devices, including digital televisions, digital direct broadcast systems, wireless communication devices, personal digital assistants (PDAs), laptop computers, desktop computers, digital cameras, digital recording devices, mobile or satellite radio telephones, and the like. Digital video devices can provide significant improvements over conventional analog video systems in creating, modifying, transmitting, storing, recording and playing full motion video sequences.

Some devices such as mobile phones and hand-held digital cameras can take and send video clips wirelessly. In general, digital devices that record video clips taken by cameras tend to exhibit unstable motions that are annoying to consumers. Unstable motion is usually measured relative to an inertial reference frame on the camera. An inertial reference frame is in a coordinate system that is either stationary or moving at a constant speed with respect to the observer. Video stabilization that minimizes or corrects the unstable motion is required for high quality video-related applications.

For sending video wirelessly, the video may be digitized and encoded. Once digitized, the video may be represented in a sequence of video frames, also known as a video sequence. By encoding data in a compressed fashion, many video encoding standards allow for improved transmission rates of video sequences. Compression can reduce the overall amount of data that needs to be transmitted for effective transmission of video sequences. Most video encoding standards utilize graphics and video compression techniques designed to facilitate video and image transmission over a narrower bandwidth than can be achieved without the compression.

In order to support compression, a digital video device typically includes an encoder for compressing digital video sequences, and a decoder for decompressing the digital video sequences. In many cases, the encoder and decoder form an integrated encoder/decoder (CODEC) that operates on blocks of pixels within frames that define the video sequence. In the International Telecommunication Union (ITU) H.264 standard, for example, the encoder typically divides a video frame to be transmitted into video blocks referred to as “macroblocks.” The ITU H.264 standard supports 16 by 16 video blocks, 16 by 8 video blocks, 8 by 16 video blocks, 8 by 8 video blocks, 8 by 4 video blocks, 4 by 8 video blocks and 4 by 4 video blocks. Other standards may support differently sized video blocks.

For each video block in a video frame, an encoder searches similarly sized video blocks of one or more immediately preceding video frames (or subsequent frames) to identify the most similar video block, referred to as the “best prediction block”. The process of comparing a current video block to video blocks of other frames is generally referred to as block-level motion estimation (BME). BME produces a motion vector for the respective block. Once a “best prediction block” is identified for a current video block, the encoder can encode the differences between the current video block and the best prediction block. This process of encoding the differences between the current video block and the best prediction block includes a process referred to as motion compensation. Motion compensation comprises a process of creating a difference block indicative of the differences between the current video block to be encoded and the best prediction block. In particular, motion compensation usually refers to the act of fetching the best prediction block using a motion vector, and then subtracting the best prediction block from an input block to generate a difference block.

After motion compensation has created the difference block, a series of additional encoding steps are typically performed to finish encoding the difference block. These additional encoding steps may depend on the encoding standard being used.

A standard which incorporates a video stabilization method does not currently exist. Hence, there are various approaches to stabilize video. Many of these algorithms rely on block-level motion estimation (BME). As described above, BME requires heuristic or exhaustive two-dimensional searches on a block by block basis. BME can be computationally burdensome.

Both video stabilization and motion compensation techniques which are less computationally burdensome are needed. A method and apparatus that could correct one or the other is a significant benefit. Even more desirable would be a method and apparatus that could perform both capabilities together in a manner that consume fewer computational resources.

### SUMMARY

Projection based techniques that improve video stabilization and may be used as a more efficient way to perform motion estimation in video encoding is presented. In particular, a non-conventional way to generate motion vectors for the blocks in a frame and for the frame as well is described.

In general, after horizontal and vertical projections are generated for a given video block, a metric called a projection correlation error (PCE) value is implemented. Subtraction between a set of projections (a projection vector) from first (current) frame i and a set of projections (a different projection vector, different can mean past or future) from a second (different) frame i−m or frame i+m yields a PCE vector. The norm of the PCE vector yields the PCE value. For the case of an L1 norm, this involves summing the absolute value difference between the projection vector and the past or future projection vector. For the case of an L2 norm, this involves summing the square value of the difference between the projection vector and the past or future projection vector. After the set of projections in one frame is shifted by one shift position, this process is repeated and another PCE value is obtained. For each shift position there will be a corresponding PCE value. Shift positions may take place in either the positive or negative horizontal direction or the positive or negative vertical direction. Once all the shift positions have been traversed, a set of PCE values in both the horizontal and vertical direction may exist for each video block being processed in a frame. The PCE values at different shift positions that result from subtracting horizontal projections from different frames are called the horizontal PCE values. Similarly, the PCE values at different shift positions that result from subtracting vertical projections from different frames are called vertical PCE values.

For each video block, the minimum horizontal PCE value and the minimum vertical PCE value may form a block motion vector. There are multiple variations on how to utilize the projections to produce a block motion vector. Some of these variations are illustrated in the embodiments below.

In one embodiment, the horizontal component of the video block motion vector is placed in a set of bins and the vertical component of the video block motion vector is placed into another set of bins. After the frame has been processed, the maximum peak across each set of bins is used to generate a frame level motion vector, and used as a global motion vector. Once the global motion vector is generated, it can be used for video stabilization.

In another embodiment, the previous embodiment uses sets of interpolated projections for generating motion vectors used in video stabilization.

In a further embodiment, the disclosure provides a video encoding system where integer pixels, interpolated pixels, or both, may be used before computing the horizontal and vertical projections during the motion estimation process.

In a further embodiment, the disclosure provides a video encoding system where the computed projections are interpolated during the motion estimation process. Motion vectors for the video blocks can then be generated from the set of interpolated projections.

In a further embodiment, any embodiments previously mentioned may be combined.

The details of one or more embodiments are set forth in the accompanying drawings and the description below. Other features, objects, and advantages will be apparent from the description, drawings and claims.

### BRIEF DESCRIPTION OF DRAWINGS

FIG. 1A is a block diagram illustrating a video encoding and decoding system employing a video stabilizer and a video encoder block which are based on techniques in accordance with an embodiment described herein.

FIG. 1B is a block diagram of two CODEC's that may be used as described in an embodiment herein.

FIG. 2 is a block diagram illustrating a video stabilizer that may be used in the device of FIG. 1A.

FIG. 3 is a flow chart illustrating the steps required to generate a global motion vector used to stabilize video based on techniques in accordance with an embodiment described herein.

FIG. 4 is a flow chart illustrating the steps required to generate a global motion vector used to stabilize video based on techniques in accordance with an embodiment described herein.

FIG. 5 is a conceptual illustration of the horizontal and vertical projections of a video block.

FIG. 6 illustrates how a horizontal projection may be generated.

FIG. 7 illustrates how a vertical projection may be generated.

FIG. 8 illustrates memories which may store sets of both horizontal and vertical projections for all video blocks in both the current frame i and a past frame i−m or future frame i+m.

FIG. 9 illustrates which functional blocks may be used to generate the PCE values between projections.

FIG. 10 illustrates an example of the L1 norm implementation of the four PCE functions used to generate the PCE values that are used to capture the four directional motions: (1) positive vertical; (2) positive horizontal; (3)negative vertical; and (4) negative horizontal.

FIG. 11 illustrates for all processed video blocks in a frame the storage of the set of PCE values. FIG. 11 also shows the selection of the minimum horizontal and the minimum vertical PCE values per processed video block that form a block motion vector.

FIG. 12A and FIG. 12B illustrate an example of interpolating any number of pixels in a video block prior to generating a projection.

FIG. 13A and FIG. 13B illustrate an example of interpolating any set of projections.

FIG. 14A and FIG. 14B illustrate an example rotating the incoming row or column of pixels before computing any projection.

FIG. 15 is a block diagram illustrating a video encoding system.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs. In general, described herein, is a non-conventional method and apparatus to generate block motion vectors.

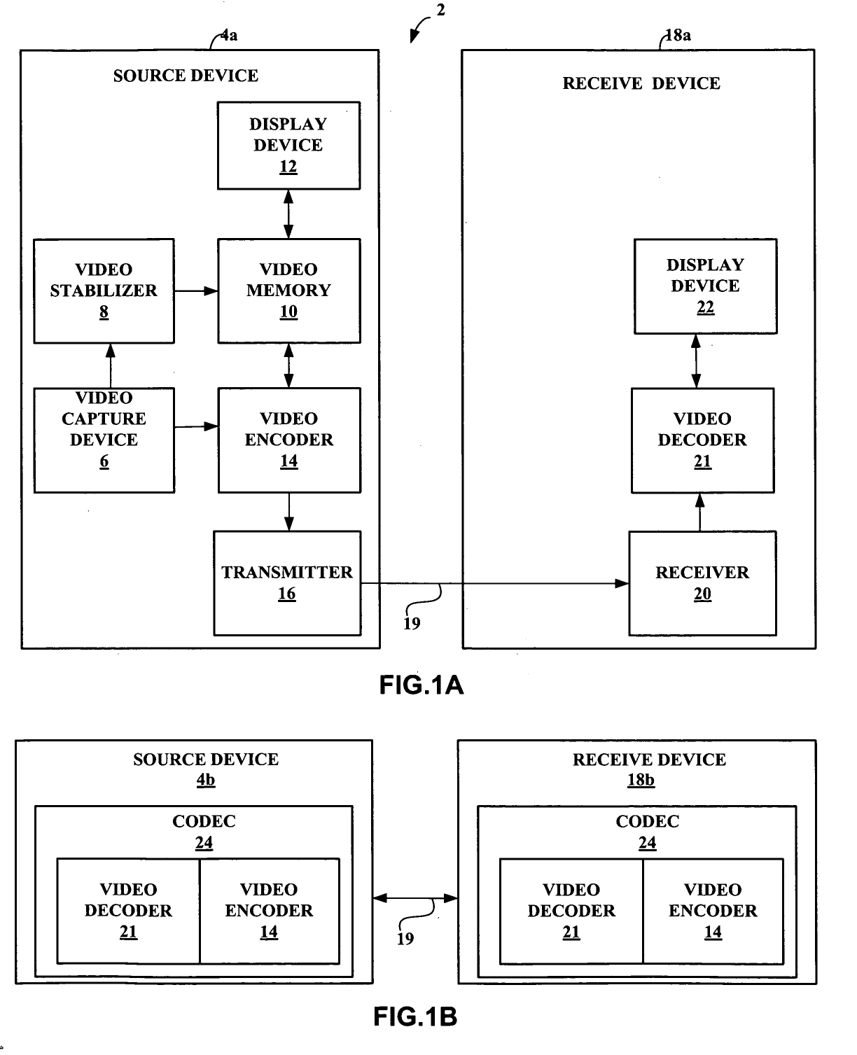

FIG. 1A is a block diagram illustrating a video encoding and decoding system 2 employing a video stabilizer and a video encoder block which are based on techniques in accordance with an embodiment described herein. As shown in FIG. 1A, the source device 4a contains a video capture device 6 that captures the video input before potentially sending the video to video stabilizer 8. After the video is stable, part of the stable video may be written into video memory 10 and may be sent to display device 12. Video encoder 14 may receive input from video memory 10 or from video capture device 6. The motion estimation block of video encoder 14 may also employ a projection based algorithm to generate block motion vectors. The encoded frames of the video sequence are sent to transmitter 16. Source device 4a transmits encoded packets or an encoded bitstream to receive device 18a via a channel 19. Line 19 may be a wireless channel or a wire-line channel. The medium can be air, or any cable or link that can connect a source device to a receive device. For example, a receiver 20 may be installed in any computer, PDA, mobile phone, digital television, etcetera, that drives a video decoder 21 to decode the above mentioned encoded bitstream. The output of the video decoder 21 may send the decoded signal to display device 22 where the decoded signal may be displayed. The source device 4a and/or the receive device 18a in whole or in part may comprise a so called “chip set” or “chip” for a mobile phone, including a combination of hardware, software, firmware, and/ or one or more microprocessors, digital signal processors (DSP's), application specific integrated circuits (ASICS), field programmable gate arrays (FPGA's), or various combinations thereof. In addition, in another embodiment, the video encoding and decoding system 2 may be in one source device 4b and one receive device 18b as part of a CODEC. Thus, source device 4b may contain at least one video CODEC and receive device 18b may contain at least one video CODEC as seen in FIG. 1B.

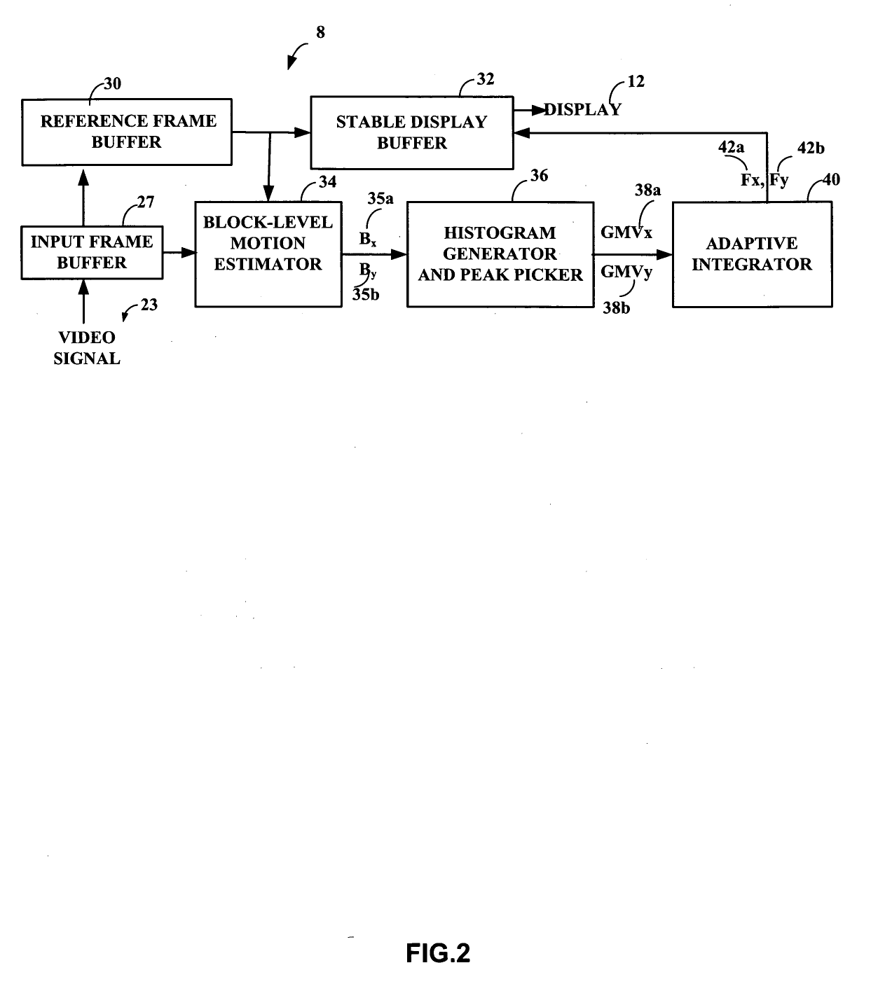

FIG. 2 is a block diagram illustrating the video stabilization process. A video signal 23 is acquired. If the video signal is analog, it is converted into a sequence of digitized frames. The video signal may already be digital and may already be a sequence of digitized frames. Each frame may be sent into video stabilizer 8 where at the input of video stabilizer 8 each frame may be stored in an input frame buffer 27. An input frame buffer 27 may contain a surrounding pixel border knows as the margin. The input frame may be used as a reference frame and placed in reference frame buffer 30. A copy of the stable portion of the reference frame is stored in stable display buffer 32. The reference frame and the input frame may be sent to block-level motion estimator 34 where a projection based technique may be used to generate block motion vectors. The projection based technique is based on computing a norm between the difference of two vectors. Each element in a vector is the result of summing pixels (integer or fractional) in a row or column of a video block. The sum of pixels is the projection. Hence, each element in the vector is a projection. One vector is formed from summing the pixels (integer or fractional) in multiple rows or multiple columns of a video block in a first frame. The other vector is formed from summing the pixels (integer or fractional) in multiple rows or multiple columns of a video block in a second frame. For the purpose of illustrating the concepts herein, the first frame will be referred to as the current frame and the second frame will be referred to as a past or future frame. The result of the norm computation is known as a projection correlation error (PCE) value. The two vectors are then shifted by one shift position (either integer or fractional) and another PCE value is computed. This process is repeated for each video block. Block motion vectors are generated by selecting the minimum PCE value for each video block. Bx 35a and By 35b represent the horizontal and vertical components of a block motion vector. These components are stored in two sets of bins. The first set stores all horizontal components, and the second set stores all the vertical components for all the processed blocks in a frame.

After all the blocks in a frame have been processed a histogram of the block motion vectors and their peaks is produced 36. The maximum peak across each set of bins is used to generate a frame level motion vector, which may be used as a global motion vector. GMVx 38a and GMVy 38b are the horizontal and vertical components of the global motion vector. GMVx 38a and GMVy 38b are sent to an adaptive integrator 40 where they are averaged in with past global motion vector components. This yields Fx 42a and Fy 42b, averaged global motion vector components, that may be sent to stable display buffer 32 and help produce a stable video sequence as may be seen in display device 12.

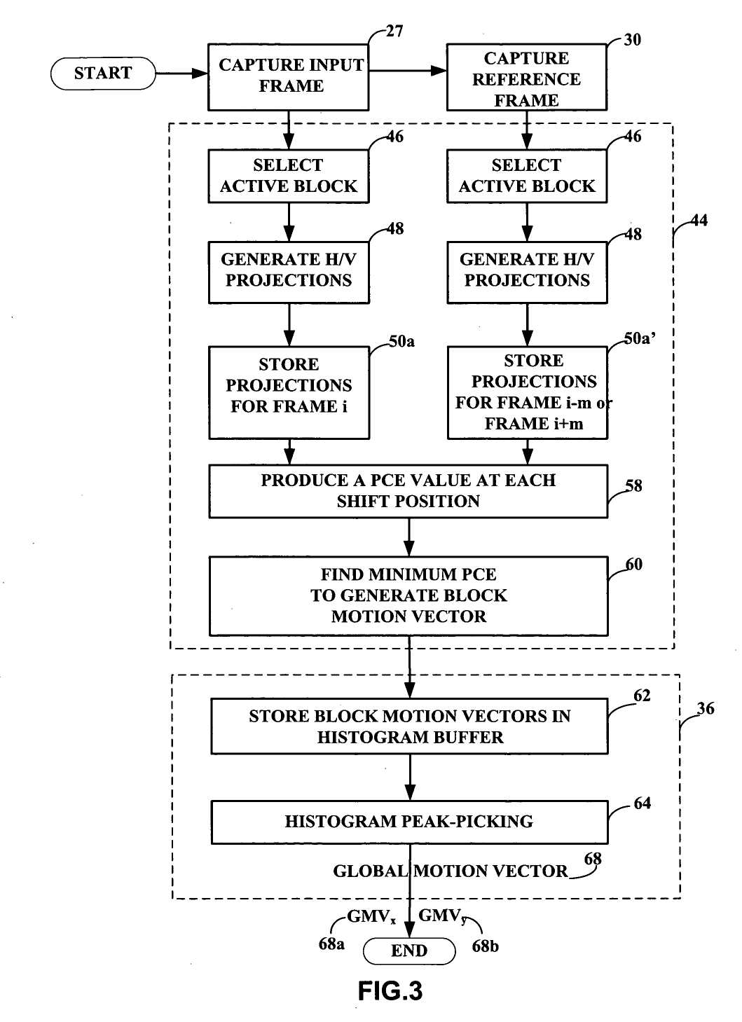

FIG. 3 is a flow chart illustrating the steps required to generate a global motion vector used to stabilize video based on techniques in accordance with an embodiment described herein. Frames in a video sequence are captured and placed in input frame buffer 27 and reference frame buffer 30. Since the process may begin anywhere in the video sequence, the reference frame may be a past frame or a sub-sequent frame. The two (input and reference) frames may be sent to block-level motion estimator 44. The frames are usually processed by parsing a frame into video blocks. These video blocks can be of any size, but typically are of size 16×16 pixels. The video blocks are passed into a block-level motion estimator block 44 of the video stabilizer, where horizontal and vertical projections 48 may be generated for each video block in the frame. After generation of projections for a video block from a first (current) frame i and a second (past) frame i−m, or a second (future) frame i+m, projections may be stored in a memory. For example, a memory 50a may store projections from frame i, and a memory 50b may also store projections. Memory 50b does not necessarily only hold projections from only one frame, frame i−m or frame i+m. It may store a small history of projections from past frames (frame i−1 to frame i−m) or future frames (frame i+1 to frame i+m) in a frame history buffer (not shown). For illustration ease, discussion is sometimes limited to only frame i−m. For simplicity, future frame i+m is not described but may take the place of past frame i−m both in the disclosure and Figures. For many cases, m=1. The PCE value functions in PCE value producer 58 use both the horizontal and vertical projections in each of these memories, 50a and 50b, respectively, for frame i and frame i−m or frame i+m.

PCE value producer58 capture movements in four directions: positive vertical (PCE value function 1), positive horizontal (PCE value function 2), negative vertical (PCE value function 3),and negative horizontal (PCE value function 4) directions. By computing a norm of a difference of two vectors, each PCE value function compares a set of projections (a vector) in one frame with a set of projections (a different vector) in another frame. All sets of comparisons across all PCE value functions may be stored. The minimum comparison (the minimum norm computation) of the PCE value functions, in each video block, is used to generate a block motion vector 60 that yields the horizontal component and vertical component of a block motion vector. The horizontal component may be stored in a first set of bins representing a histogram buffer, and the vertical component may be stored in a second set of bins representing a histogram buffer. Thus, block motion vectors may be stored in a histogram buffer 62. Histogram peak-picking 64 then picks the maximum peak from the first set of bins which is designated as the horizontal component of the Global Motion Vector 68, GMVx 68a. Similarly, histogram peak-picking 64 then picks the maximum peak from the second set of bins which is designated as the vertical component of the Global Motion Vector 68, GMVy 68b.

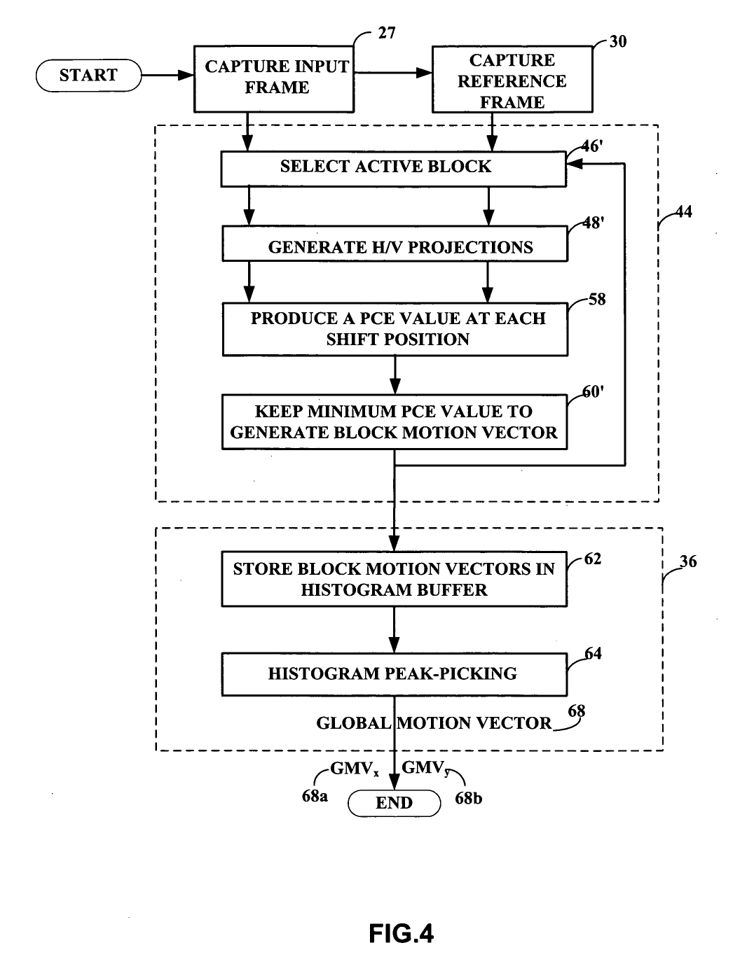

FIG. 4 is also a flow chart illustrating the steps required to generate a global motion vector used to stabilize video based on techniques in accordance with an embodiment described herein. FIG. 4 is similar to FIG. 3. Unlike FIG. 3, there are not two parallel branches to select the active block in each frame and compute the horizontal and vertical (H/V) projections in each frame. Additionally, all projections are not stored in memory. The minimum PCE value is computed by keeping the minimum PCE value 60 that is computed for each video block. After a PCE value is computed, the PCE value is compared to the previous PCE value computed. If the last PCE value is smaller than the previous PCE value, it is designated as the minimum PCE value. For each shift position, the comparison of PCE values is done. At the end of the process, the minimum horizontal PCE value and minimum vertical PCE value are sent to form a histogram 62.

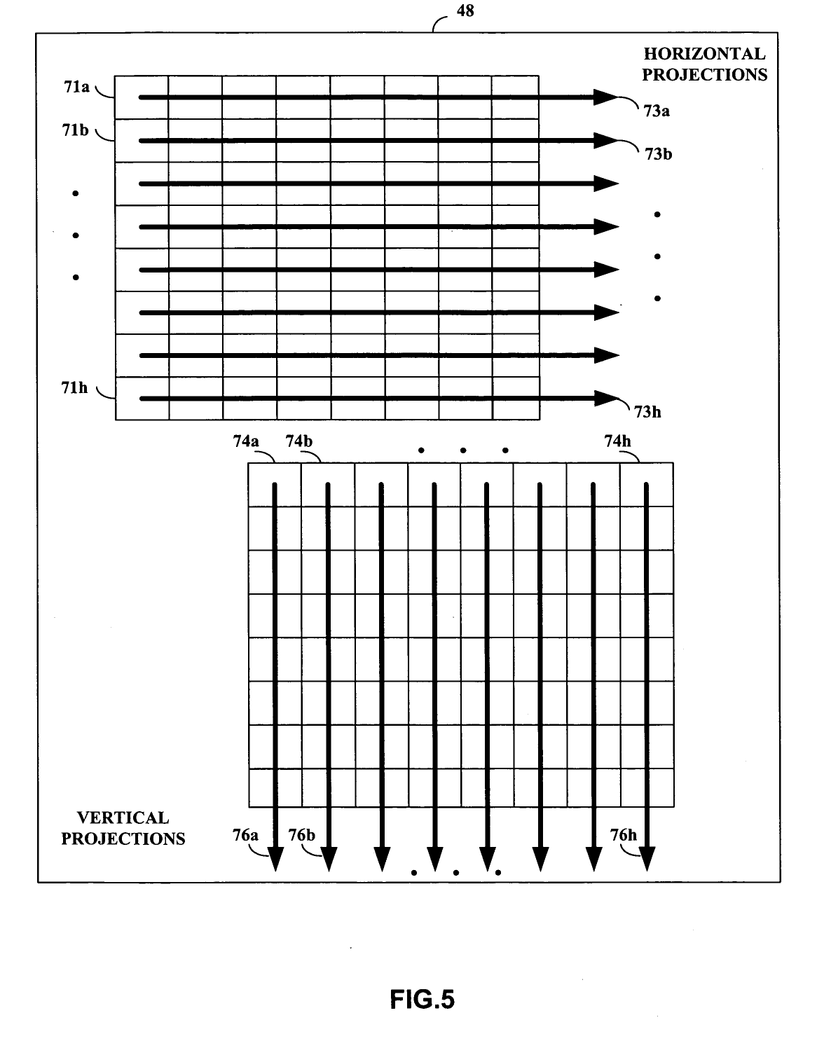

FIG. 5 illustrates horizontal and vertical projections being generated on an 8×8 video block, although these projections may be generated on any size video block and are typically 16×16 in size. Here, the 8×8 video block is shown for exemplary purposes. Rows 71a through 71h contain pixels. The pixels may be integer or fractional. The bold horizontal lines represent the horizontal projections 73a through 73h. Columns 74a through 74h contain pixels. The pixels may be integer or fractional. The bold vertical lines represent the vertical projections 76a through 76h. The intention of the illustration is that any of these projections may be generated in any frame. It should also be pointed out that other sets of projections, e.g., diagonal, every other row, every other column, etc. . . . may also be generated.

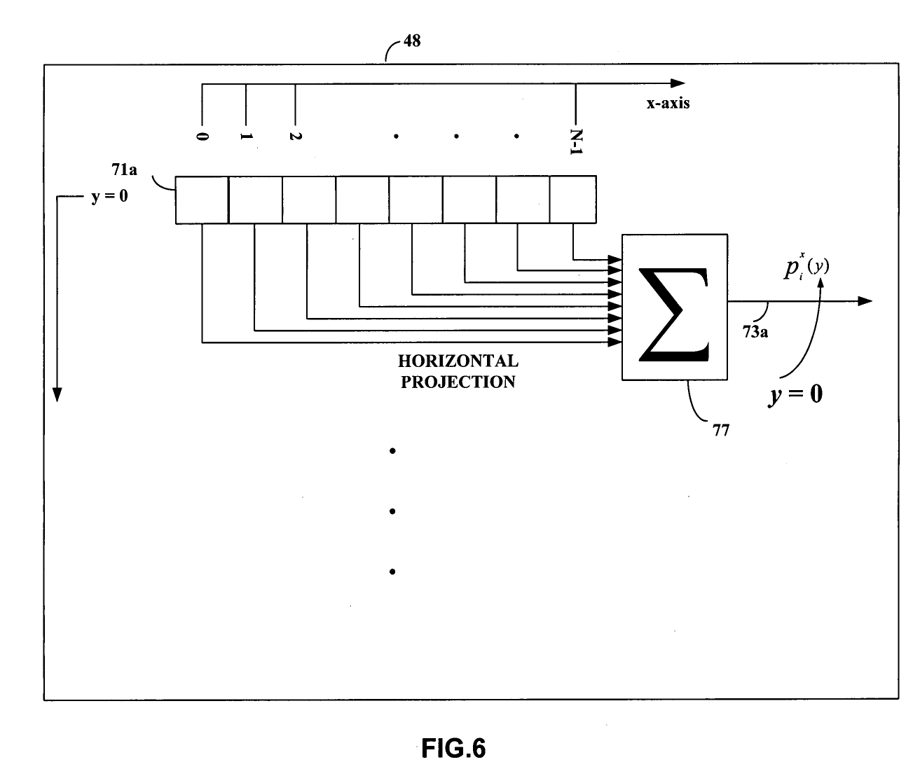

FIG. 6 is an illustration of how a horizontal projection is generated for each row in a video block. In this illustration, the top row 71a of a video block is designated to be positioned at y=0, and the furthest left pixel in the video block is positioned at x=0. A horizontal projection is computed by summing all the pixels in a video block row via a summer 77. Pixels from Row 71a are sent to summer 77, where summer 77 starts summing at the pixel location x=0 and accumulates the pixel values until it reaches the end of the video block row pixel located at x=N−1. The output of summer 77 is a number. In the case where the row being summed is video block row 71a, the number is horizontal projection 73a. In general, a horizontal projection can also be represented mathematically by:

$${p}_{i}^{x} ( y ) = {\sum }_{x = 0}^{N - 1} block ( x , y ) \qquad ( Equation 1 )$$

where block(x,y) is a video block. In Equation 1, the superscript on the P denotes the type of projection. In this instance, Equation 1 is an x-projection or horizontal projection. The subscript on the P denotes that the projection is for frame i. The summation starts at block pixel x=0, the furthest left pixel in block(x,y), and ends at block pixel x=N−1, the furthest right pixel in block(x,y). The projection P is a function of y, the vertical location of the video block row. Horizontal projection 73a is generated at video row location y=0. Each projection from 73a to projection 73h increases by one integer pixel value y. These projections may take place for all video blocks processed, and also may be taken on fractional pixels.

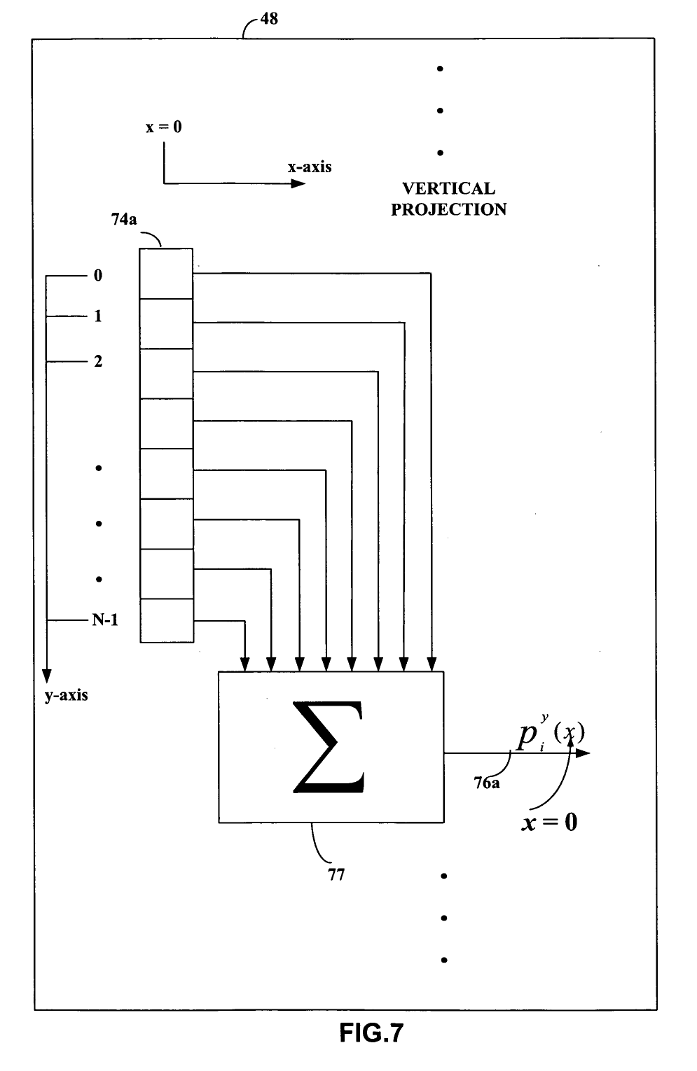

Vertical projections are generated in a similar manner. FIG. 7 is an illustration of how a vertical projection is generated for each column in a video block. In this illustration, the left most column 74a of a video block is designated to be positioned at x=0, and the top pixel in the column is positioned at y=0. A vertical projection is generated by summing all the pixels in a video block column via a summer 77. Pixels in Column 74a are sent to summer 77, where, summer 77 starts summing at the pixel located at y=0 and accumulates the pixel values until it reaches the bottom of the video block column which is located at y=N−1. The output of summer 77 is a number. In the case where the column being summed is video block column 74a, the number is vertical projection 76a. In general, a vertical projection can also be represented mathematically by:

$${p}_{i}^{y} ( x ) = {\sum }_{y = 0}^{M - 1} block ( x , y ) \qquad ( Equation 2 )$$

where block(x,y) is a video block. In Equation 2, the superscript on the P denotes that it is a y-projection or vertical projection. The subscript on the P denotes the frame number. In Equation 2, the projection is for frame i. The summation starts at block pixel x=0, the furthest left pixel in block(x,y), and ends at block pixel x=M−1, the furthest right pixel in block(x,y). Projection P is a function of x, the horizontal position of the video block column. Vertical projection 76a is generated starting at video column location x=0. Each projection from 76a to projection 76h increases by one integer pixel value x, and also may be taken on fractional pixels.

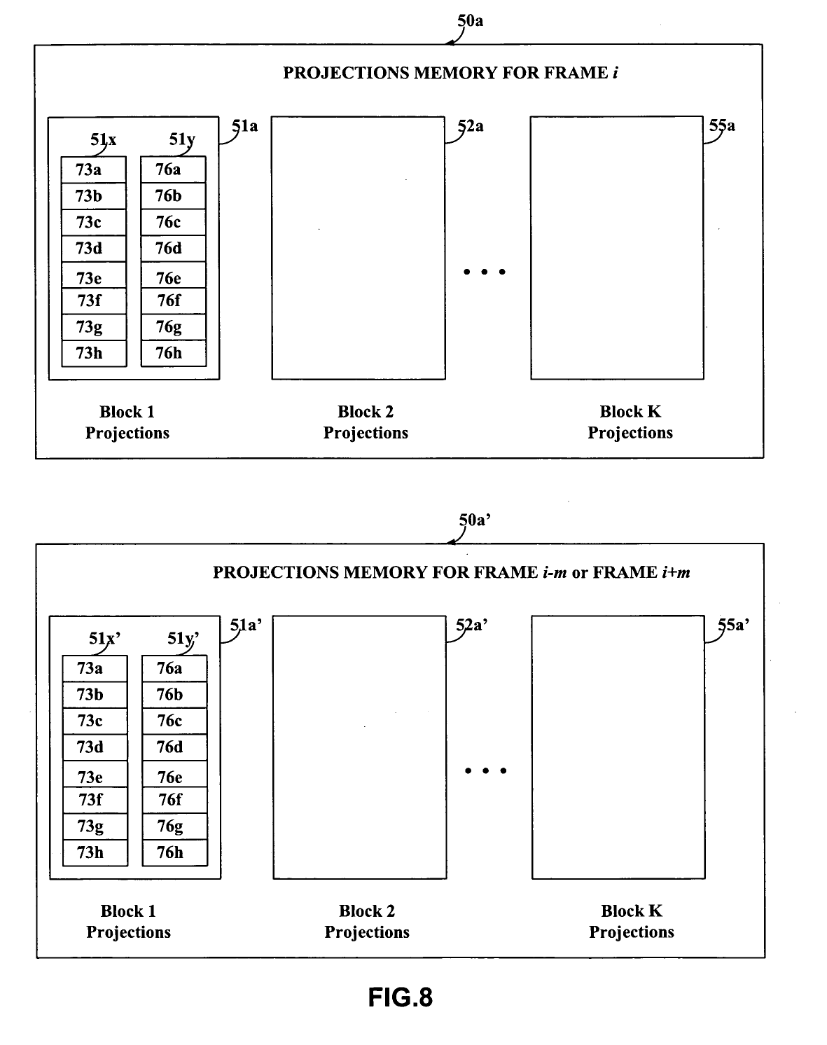

FIG. 8 illustrates a memory which stores the sets of both horizontal and vertical projections for all video blocks in frame i. Memory 50a holds projections for frame i. For illustration purposes, memory 50a is partitioned to illustrate that all processed projections may be stored. The memory may be partitioned to group the set of horizontal projections and the set of vertical projections. The set of all generated horizontal projections of video block 1 from frame i may be represented as horizontal projection vector1 (hpvᵢ1) 51x. For exemplary purposes, the set of horizontal projections 73a through 73h is shown. The set of all generated vertical projections of video block 1 may be represented as vertical projection vector1 (vpvᵢ1) 51y. The two sets in memory 51a, 52a, and 55a represent the horizontal projection vectors and vertical projection vectors of video blocks 1, 2, and K (the last processed video block in the frame), in a similar manner. The three dots imply that there may be many video blocks between block 2 and block K. Memory 50a′ which stores both horizontal and vertical projection vectors for all video blocks in frame i−m and may also be partitioned like memory 50a and has the associated prime on the labeled objects in the figure. The intention of the illustration of FIG. 8 is to show that both horizontal and vertical projections may be stored in a memory and in addition partitioned as illustrated. Partial memory or temporary memory storage may also be used depending on what order computations are made in flow processes described in FIG. 3 and FIG. 4.

In order to estimate the motion that occurs between current frame i and a past frame i−m (or future frame i+m) a metric known as a projection correlation error (PCE) value is implemented. As mentioned above, future frame i+m is not always described but may take the place of past frame i−m both in the disclosure and figures. Subtraction between a set of horizontal projections (a horizontal projection vector) from first (current) frame i and a set of horizontal projections (a different horizontal projection vector) from a second (past or future) frame yields a horizontal PCE vector. Similarly, subtraction between a set of vertical projections (a vertical projection vector) from first (current) frame i and a set of vertical projections (a different vertical projection vector) from a second (past or future) frame yields a vertical PCE vector. The norm of the horizontal PCE vector yields a horizontal PCE value. The norm of the vertical PCE vector yields a vertical PCE value. For the case of an L1 norm, this involves summing the absolute value of the difference between the current projection vector and the different (past or future) projection vector. For the case of an L2 norm, this involves summing the square value of the difference between the current projection vector and the different (past or future) projection vector. After a set of projections in a video block in a frame are shifted by one shift position this process is repeated and another PCE value is obtained. For each shift position there will be a corresponding PCE value. In general, shift positions may be positive or negative. As described, shift positions take on positive values. However, the order of subtraction varies to capture the positive or negative horizontal direction or the positive or negative vertical direction. Once all the shift positions have been traversed for both the horizontal and vertical sets of projections, a set of PCE values in both the horizontal and vertical direction will exist for each video block being processed in a frame.

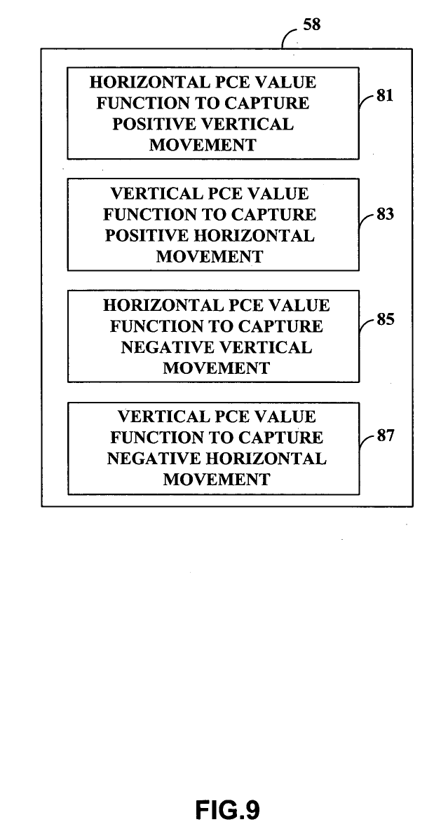

Hence, shown in FIG. 9, is the case where the PCE values are generated via four separate PCE value functions. PCE value producer 58 is composed of two PCE value functions to capture the positive vertical and horizontal direction movements, and two PCE value functions to capture the negative vertical and horizontal direction movements. Horizontal PCE value function to capture positive vertical movement 81 compares a fixed horizontal projection vector from frame i with a shifting horizontal projection vector from frame i−m or frame i+m. Vertical PCE value function to capture positive horizontal movement 83 compares a a vertical fixed projection vector from frame i with a vertical shifting projection vector from frame i−m or frame i+m. Horizontal PCE value function to capture negative vertical movement 85 compares a shifting horizontal projection vector from frame i with a fixed horizontal projection vector in frame i−m or frame i+m. Vertical PCE value function to capture negative horizontal movement 87 compares a shifting vertical projection vector from frame i with a fixed vertical projection vector from frame i−m or frame i+m.

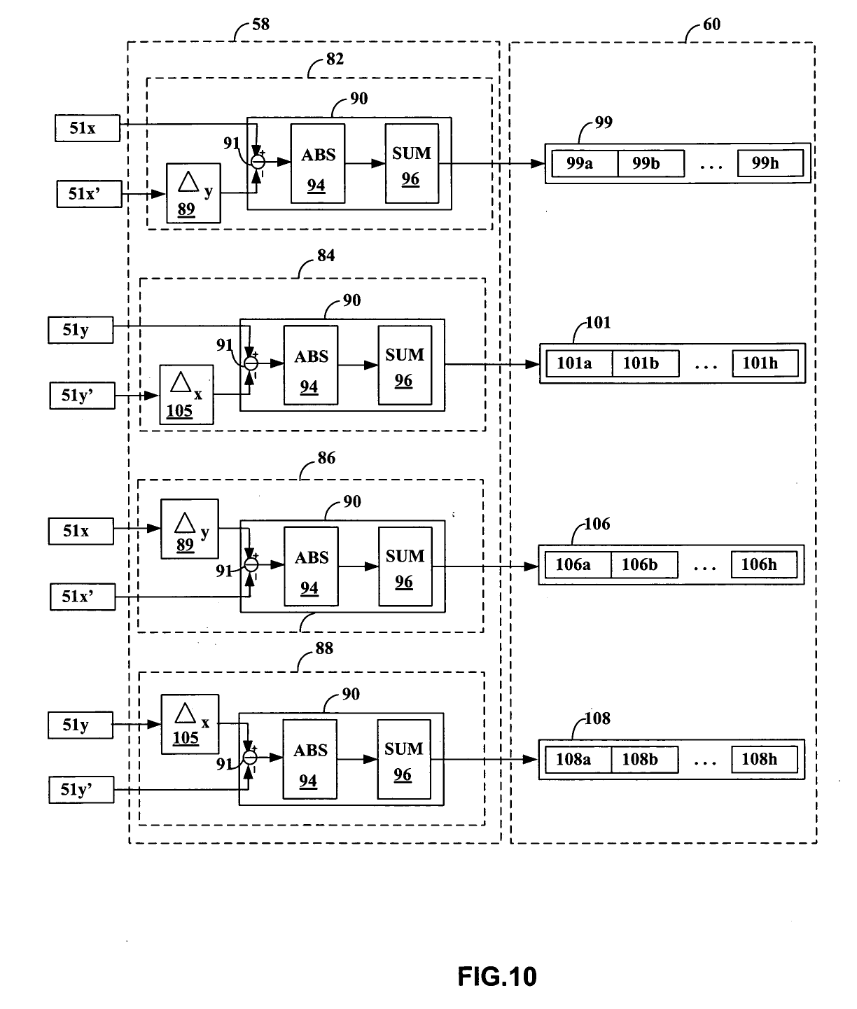

Those ordinary skilled in the art will recognize that the PCE value metric can be more quickly implemented with an L1 norm, since it requires less operations. As an example, a more detailed view of the inner workings of the PCE value functions implementing an L1 norm is illustrated in FIG. 10. Horizontal PCE value function to capture positive vertical movement 81 may be implemented by configuring a projection correlator1 82 to take a horizontal PCE vector 51x from frame i and a horizontal projection vector 51x′ from frame i−m and subtract 91 them to yield a horizontal projection correlation error (PCE) vector. Inside norm implementor 90, the absolute value 94 is taken and all the elements of the horizontal PCE vector are summed 96, i.e. yielding a horizontal PCE value at an initial shift position. This process performed by projection correlator1 82 yields a set of horizontal PCE values 99a, 99b, through 99h for each Δ_{y} shift position made by shifter 89 on horizontal projection vector 51x′. The set of horizontal PCE values are labeled 99.

Mathematically, the set (for all values of Δ_{y}) of horizontal PCE values to estimate a positive vertical movement between frames is captured by Equation 3 below:

$${PCE}_{+}^{x} ( {Δ}_{y} ) = {\sum }_{y = 0}^{M - {Δ}_{y} - 1} \vert {p}_{i}^{x} ( y ) - {p}_{i - m}^{x} ( {Δ}_{y} + y ) \vert \qquad ( Equation 3 )$$

The + subscript on the PCE value indicates a positive vertical movement between frames. The x superscript on the PCE value denotes that this is a horizontal PCE value. The Δ_{y} in the PCE value argument denotes that the horizontal PCE value is a function of the vertical shift position, Δ_{y}.

Estimation of the positive horizontal movement between frames is also illustrated in FIG. 10. Vertical PCE value function to capture positive horizontal movement 83 may be implemented by configuring a projection correlator2 84 to take a vertical projection vector 51y from frame i and a vertical projection vector 51y′ from frame i−m or frame i+m and subtract 91 them to yield a vertical PCE vector. Inside norm implementor 90, the absolute value 94 is taken and all the elements of the vertical PCE vector are summed 96, i.e. yielding a vertical PCE value at an initial shift position. This process performed by projection correlator2 84 yields a set of vertical PCE values 101a, 101b, through 101h for each Δₓ shift position made by shifter 105 on vertical projection vector 51y′. The set of vertical PCE values are labeled 101.

Mathematically, the set (for all values of Δₓ) of vertical PCE values to estimate a positive horizontal movement between frames is captured by Equation 4 below:

$${PCE}_{+}^{y} ( {Δ}_{x} ) = {\sum }_{x = 0}^{M - {Δ}_{x} - 1} \vert {p}_{i}^{y} ( x ) - {p}_{i - m}^{y} ( {Δ}_{x} + x ) \vert \qquad ( Equation 4 )$$

The + subscript on the PCE value indicates a positive horizontal movement between frames. The y superscript on the PCE value denotes that this is a vertical PCE value. The Δₓ in the PCE value argument denotes that the vertical PCE value is a function of the horizontal shift position, Δₓ.

Similarly, estimation of the negative horizontal movement between frames is illustrated in FIG. 10. Horizontal PCE value function to capture negative vertical movement 85 may be implemented by configuring a projection correlator3 86 to take a horizontal projection vector 51x′ from frame i−m or frame i+m and a horizontal projection vector 51x from frame i and subtract 91 them to yield a horizontal PCE vector. Inside norm implementor 90, the absolute value 94 is taken and all the elements of the horizontal PCE vector are summed 96, i.e. yielding a horizontal PCE value at an initial shift position. This process performed by projection correlator3 86 yields a set of horizontal PCE values 106a, 106b, through 106h for each Δ_{y} shift position made by shifter 89 on horizontal projection vector 51x. The set of horizontal PCE values are labeled 106.

Mathematically, the set (for all values of Δ_{y}) of horizontal PCE values to estimate a negative vertical movement between frames is captured by Equation 5 below:

$${PCE}_{-}^{x} ( {Δ}_{y} ) = {\sum }_{y = 0}^{N - {Δ}_{y} - 1} \vert {p}_{i}^{x} ( {Δ}_{y} + y ) - {p}_{i - m}^{x} ( y ) \vert \qquad ( Equation 5 )$$

The − subscript on the PCE value indicates a negative vertical movement between frames. The x superscript on the PCE value denotes that this is a horizontal PCE value. The Δₓ in the PCE value argument denotes that the horizontal PCE value is a function of the vertical shift position, Δ_{y}.

Also, estimation of the negative vertical movement between frames is illustrated in FIG. 10. Vertical PCE value function to capture negative horizontal movement 87 may be implemented by configuring a projection correlator4 88 to take a vertical projection vector 51y′ from frame i−m or frame i+m and a vertical projection vector 51y from frame i and subtract 91 them to yield a vertical PCE vector. Inside norm implementor 90, the absolute value 94 is taken and all the elements of the vertical PCE vector are summed 96, i.e. yielding a vertical PCE value at an initial shift position. This process performed by projection correlator4 88 yields a set of vertical PCE values 108a, 108b, through 108h for each Δₓ shift position made by shifter 105 on vertical projection vector 51y′. The set of vertical PCE values are labeled 108.

Mathematically, the set (for all values of Δₓ) of vertical PCE values to estimate a negative horizontal movement between frames is captured by Equation 6 below:

$${PCE}_{-}^{y} ( {Δ}_{x} ) = {\sum }_{x = 0}^{N - {Δ}_{x} - 1} \vert {p}_{i}^{y} ( {Δ}_{x} + x ) - {p}_{i - m}^{y} ( x ) \vert \qquad ( Equation 6 )$$

The − subscript on the PCE value indicates a negative horizontal movement between frames. The y superscript on the PCE value denotes that this is a vertical PCE. The Δₓ in the PCE value argument denotes that the vertical PCE value is a function of the horizontal shift position, Δₓ.

The paragraphs above described using four projection correlators configured to implement the PCE value functions. There may be another embodiment (not shown) where only one projection correlator may be configured to implement all four PCE value functions. There may also be another embodiment (now shown) where one projection correlator may be configured to implement the PCE value functions that capture the movement in the horizontal direction and another projection correlator that may be configured to implement PCE value functions that capture the movement in the vertical direction. There may also be an embodiment (not shown) where multiple projection correlators (more than four) are working either serially or in parallel on multiple video blocks in a frame (past, future or current).

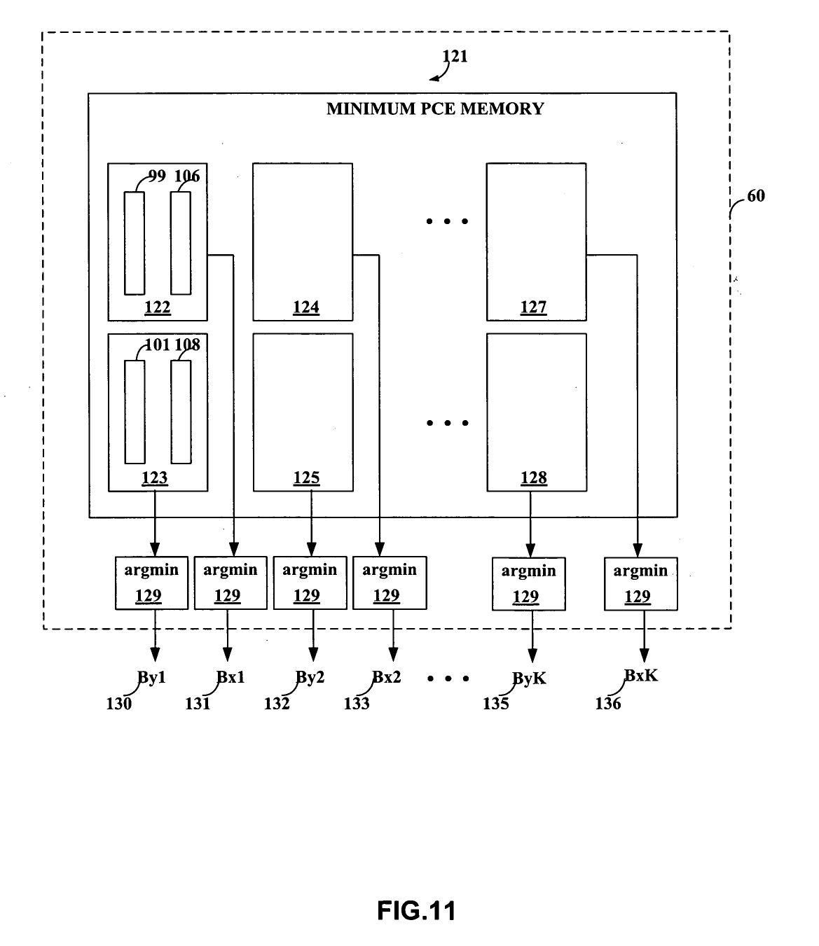

For each video block, a minimum horizontal PCE and minimum vertical PCE value is generated. This may be done by storing the set of vertical and horizontal PCE values in a memory 121, as illustrated in FIG. 11. Memory 122 may store the set of projections for video block 1 that capture the positive and negative horizontal direction movements of frame i. Memory 123 may store the set of projections for video block 1 that capture the positive and negative vertical direction movements of frame i. Similarly, memory 124 may store the set of projections for video block 2 that capture the positive and negative horizontal direction movements of frame i. Memory 125 may store the set of projections for video block 2 that capture the positive and negative vertical direction movements of frame i. In general, there may be a memory 127 which may store the set of projections for video block K that capture the positive and negative horizontal direction movements of frame i. Similarly, there may be a memory 128 which may store the set of projections for video block K that capture the positive and negative vertical direction of frame i. It is inferred through the two sets of three horizontal dots that the set of all projections may be stored in memory 121. Argmin 129 finds the minimum PCE value. Each video block motion vector may be found by combining the appropriate output of each argmin block 129. For example, By1 130 and Bx1 131 form the block motion vector for video block 1. By2 132 and Bx2 133 form the block motion vector for video block 2. In general, ByK 135 and BxK 136 form the block motion vector for video block K, where K may be any processed video block in a frame. Argmin 129 may also find the minimum PCE value by comparing the PCE values as they are generated as described by the flowchart in FIG. 4.

Once block motion vectors are generated the horizontal components may be stored in a first set of bins representing a histogram buffer, and the vertical components may be stored in a second set of bins representing a histogram buffer. Thus, block motion vectors may be stored in a histogram buffer 62, as shown in FIG. 4. Histogram peak-picking 64 then picks the maximum peak from the first set of bins which may be designated as the horizontal component of the Global Motion Vector 68, GMVx 68a. Similarly, histogram peak-picking 64 then picks the maximum peak from the second set of bins which may be designated as the vertical component of the Global Motion Vector 68, GMVy 68b.

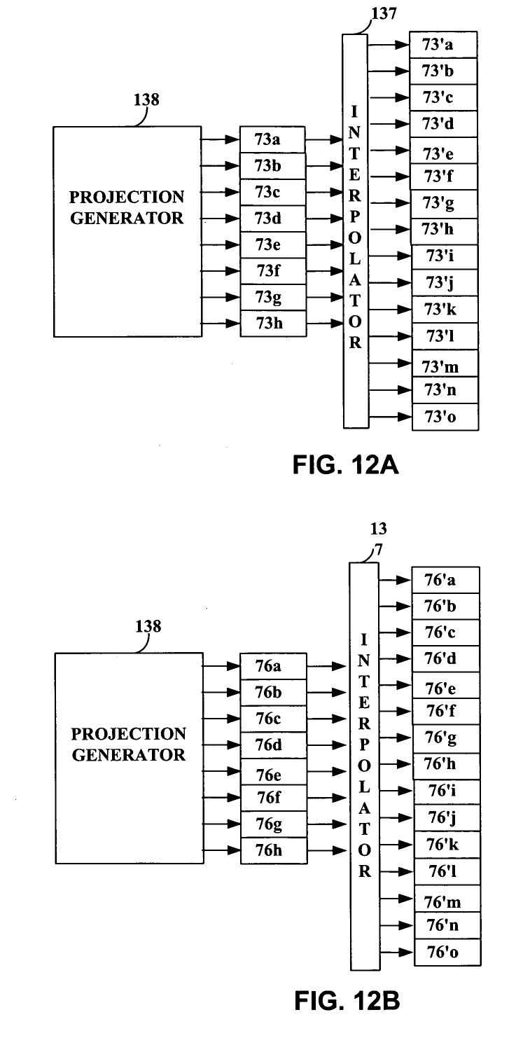

Other embodiments exist where the projections may be interpolated. As an example, in FIG. 12A, projection generator 138 generates a set of horizontal projections, 73a through 73h, which are interpolated by interpolator 137. Conventionally, after interpolation by a factor of N, there are N times the number of projections minus one. In this example, the set of 8 projections, 73a through 73h being interpolated (N=2) yields 15 (2*8−1) interpolated projections, 73′a through 73′o. Similarly, in FIG. 12B, projection generator 138 generates a set of vertical projections, 76a through 76h, which are interpolated by interpolator 137. In the example in FIG. 12B, the set of 8 projections, 76a through 76h being interpolated (N=2) also yields 15 interpolated projections, 76′a through 76′o.

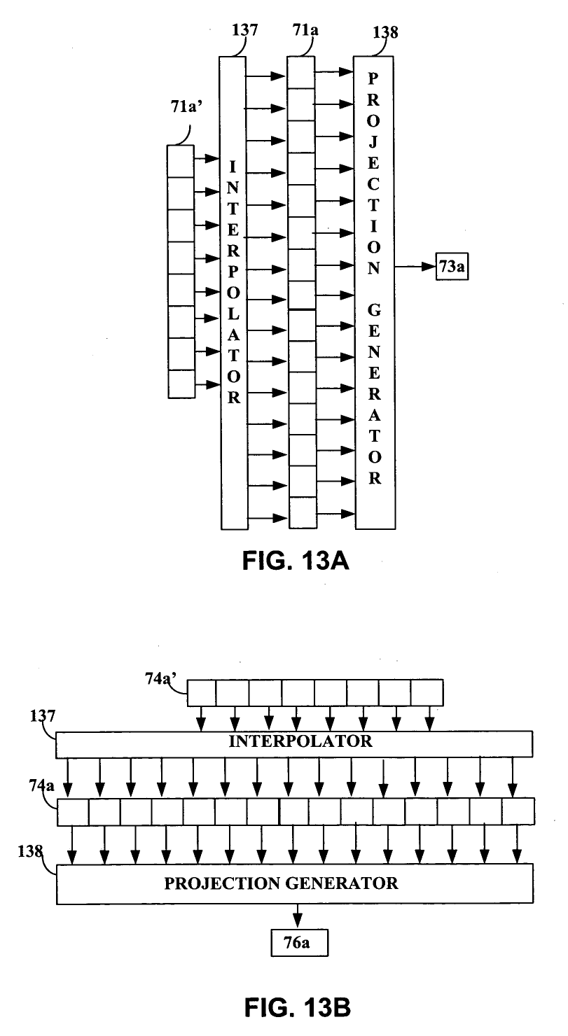

In addition, other embodiments exist where before a projection is made by summing the pixels, the pixels may be interpolated. FIG. 13A shows an example of a one row 71a′ of pixels prior to being interpolated by interpolator 137. After interpolation the. row 71a of pixels may be used by projection generator 138 which may be configured to generate a horizontal projection 73a. It should be pointed out that row 71a of interpolated pixels, contains 2*N−1 the number of pixels in row 71a′. Projection 73a may then be generated from interpolated (also may be known as fractional) pixels. Similarly, FIG. 13B shows an example of one column of pixels 74a′ prior to being interpolated by interpolator 137. After interpolation a column 74a of interpolated (or fractional) pixels may be used by projection generator 138 which may be configured to generate a vertical projection 76a. As in the example in FIG. 12A, it should be pointed out that a column, e.g., 74a of interpolated pixels, contains 2*N−1 the number of pixels than column 74a′. By interpolating the row or column of pixels there is a finer spatial resolution on the pixels prior to generating the projections.

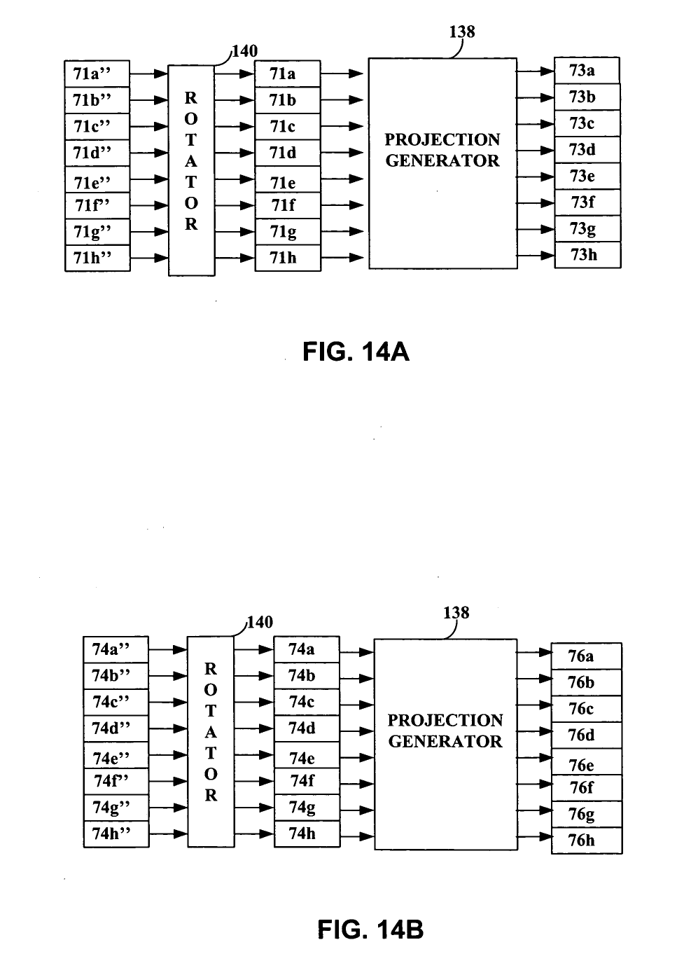

In another embodiment, pixels in a video block may be rotated by an angle before projections are generated. FIG. 14A shows an example of a set of row 71a″-71h″ pixels, that may be rotated with a rotator 140 before horizontal projections are generated. Similarly, FIG. 14B shows an example of a set of column 74a″-74h″ pixels that may be rotated with a rotator 140 to produce column 74a-74h pixels before vertical projections are generated.

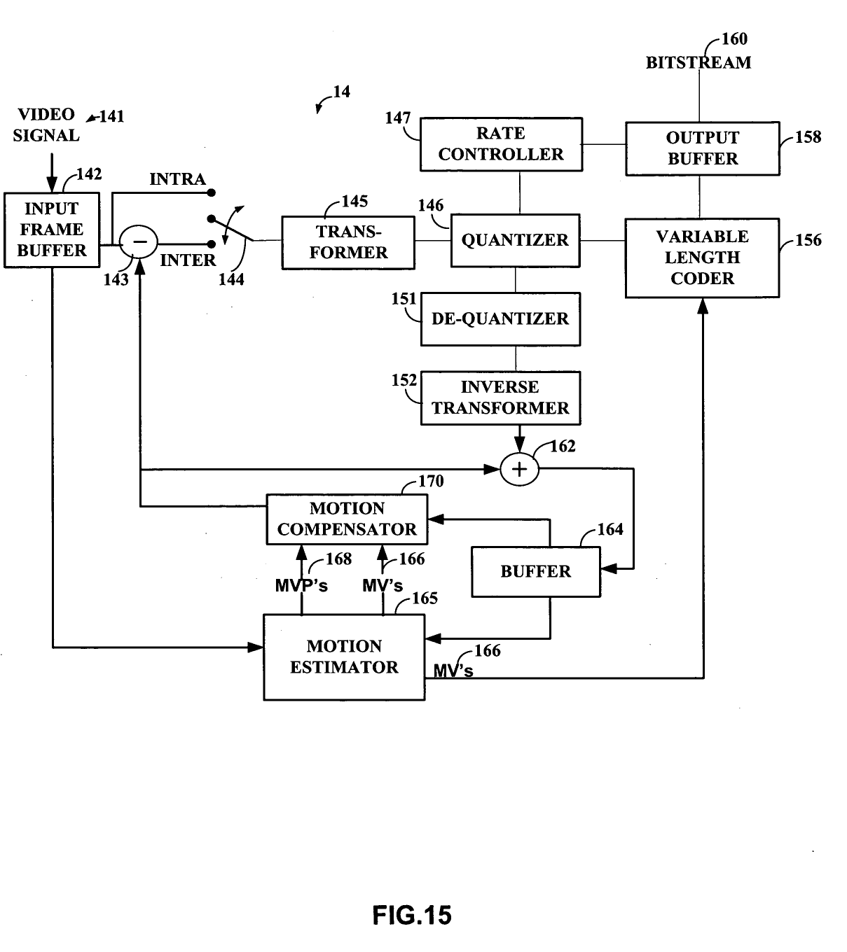

What has been described so far is the generation of horizontal and vertical projections and the various embodiments for the purpose of generating a global motion vector for video stabilization. However, in a further embodiment, the method and apparatus of generating block motion vectors may be used to encode a sequence of frames. FIG. 15 shows a typical video encoder. A video signal 141 is acquired. As mentioned above, if the signal is analog it is converted to a sequence of digital frames. The video signal may already be digital and thus is already a sequence of digital frames. Each frame may be sent into an input frame buffer 142 of video encoder device 14. An input frame from input frame buffer 142 may contain a surrounding pixel border knows as the margin. The input frame may be parsed into blocks (the video blocks can be of any size, but often the standard sizes are 4×4, 8×8, or 16×16) and sent to subtractor 143 which subtracts previous motion compensated blocks or frames. If switch 144 is enabling an inter-frame encoding, then the resulting difference is compressed through transformer 145. Transformer 145 converts the representation in the block from the pixel domain to the spatial frequency domain. For example, transformer 145 may take a discrete cosine transform (DCT). The output of transformer 145 may be quantized by quantizer 146. Rate controller 148 may set the number of quantization bits used by quantizer 146. After quantization, the resulting output may be sent to two separate structures: (1) a de-quantizer 151 which de-quantizes the quantized output; and (2) the variable length coder 156 which encodes the quantized outputs so that it is easier to detect errors when eventually reconstructing the block or frame in the decoder. After the variable length coder 156 encodes the quantized output it sends it to output buffer 158 which sends the output to produce bitstream 160 and to rate controller 148 (mentioned above). De-quantizer 151 and inverse transformer 152 work together to reconstruct the original block that went into transformer 145. The reconstructed signal is added to a motion compensated version of the signal through adder 162 and stored in buffer 164. Out of buffer 164 the signal is sent to motion estimator 165. In motion estimator 165, the novel projection based technique described throughout this disclosure may be used to generate block motion vectors (MV) 166 and also (block) motion vector predictors (MVP) 168 that can be used in motion compensator 170. The following procedures may be used to compute MVP 168, the motion vector predictor. In this example, the MVP 168 is calculated from the block motion vectors of the three neighboring macroblocks. MVP=0, if none of the neighboring block motion vectors are available; MVP=one available MV, if one neighboring block motion vector is available; MVP=median (2 MVs, 0), if two of the neighboring block motion vectors are available; MVP=median(3 Mvs), if all the three neighboring block motion vectors are available. The output of motion compensation block 170 can then be subtracted from an input frame in input frame buffer signal 142 through subtractor 143. If switch 144 is enabling intra-frame encoding, then subtractor 143 is bypassed and a subtraction is not made during that particular frame.

A number of different embodiments have been described. The techniques may be capable of improving video encoding by improving motion estimation. The techniques may also improve video stabilization. The techniques may be implemented in hardware, software, firmware, or any combination thereof. If implemented in software, the techniques may be directed to a computer-readable medium comprising computer-readable program code (also may be called computer-code), that when executed in a device that encodes video sequences, performs one or more of the methods mentioned above.

The computer-readable program code may be stored on memory in the form of computer readable instructions. In that case, a processor such as a DSP may execute instructions stored in memory in order to carry out one or more of the techniques described herein. In some cases, the techniques may be executed by a DSP that invokes various hardware components such as a motion estimator to accelerate the encoding process. In other cases, the video encoder may be implemented as a microprocessor, one or more application specific integrated circuits (ASICs), one or more field programmable gate arrays (FPGAs), or some other hardware-software combination. These and other embodiments are within the scope of the following claims.

1. An apparatus configured to process video blocks, comprising:
a first projection generator configured to generate at least one set of projections for a video block in a first frame;
a second projection generator configured to generate at least one set of projections for a video block in a second frame; and
a projection correlator configured to compare the at least one set projections from the first frame with the at least one set of projections from the second frame and configured to produce at least one minimum projection correlation error (PCE) value as a result of the comparison.

2. The apparatus of claim 1, wherein the projection correlator is further configured to produce at least one minimum PCE value for generating at least one block motion vector.

3. The apparatus of claim 2, wherein the projection correlator is further configured to utilize at least one block motion vector to generate a global motion vector for video stabilization.

4. The apparatus of claim 2, wherein the projection correlator is further configured to utilize at least one block motion vector for video encoding.

5. The apparatus of claim 1, wherein the projection correlator is coupled to a memory for storing at least one minimum PCE value.

6. The apparatus of claim 1, wherein the projection correlator comprises a shifter for shift aligning a first set of the at least one set of projections for a video block in the first frame with a different set of the at least one set of projections for a video block in the second frame.

7. The apparatus of claim 6, wherein the first set of projections and the different set of projections comprise horizontal projections.

8. The apparatus of claim 6, wherein the first set of projections and the different set of projections comprise vertical projections.

9. The apparatus of claim 6, wherein the first set of projections is a projection vector and the different set of projections is a different projection vector.

10. The apparatus of claim 6, wherein the projection correlator comprises a subtractor for performing a subtraction operation between the first projection vector and the different projection vector to generate a PCE vector.

11. The apparatus of claim 10, wherein a norm of the PCE vector is taken to generate a PCE value.

12. The apparatus of claim 11, wherein the norm is an L1 norm.

13. The apparatus of claim 1, wherein the projection correlator is further configured to implement the following equations given by:
$${PCE}_{+}^{x} ( {Δ}_{y} ) = {\sum }_{y = 0}^{N - {Δ}_{y} - 1} \vert {p}_{i}^{x} ( y ) - {p}_{i - m}^{x} ( {Δ}_{y} + y ) \vert$$
to capture movements in a positive y (vertical) direction;
$${PCE}_{+}^{y} ( {Δ}_{x} ) = {\sum }_{x = 0}^{M - {Δ}_{x} - 1} \vert {p}_{i}^{x} ( x ) - {p}_{i - m}^{y} ( {Δ}_{x} + x ) \vert$$
to capture movements in a positive x (horizontal) direction;
$${PCE}_{-}^{x} ( {Δ}_{y} ) = {\sum }_{y = 0}^{N - {Δ}_{y} - 1} \vert {p}_{i}^{x} ( {Δ}_{y} + y ) - {p}_{i - m}^{x} ( y ) \vert$$
to capture movements in a negative y (vertical) direction;
$${PCE}_{-}^{y} ( {Δ}_{x} ) = {\sum }_{x = 0}^{M - {Δ}_{x} - 1} \vert {p}_{i}^{y} ( {Δ}_{x} + x ) - {p}_{i - m}^{y} ( x ) \vert$$
to capture movements in a negative x (horizontal) direction;
where M is at most the maximum number of columns in a video block;
where Δₓ is a shift position between a vertical projection in frame i and frame i−m;
where N is at most the maximum number of rows in a video block
where Δ_{y} is a shift position between a horizontal projection in frame i and frame i−m; and
where i−m is replaced by i+m if comparing a current frame to a future frame.

14. The apparatus of claim 1, wherein the first projection generator is further configured to accept a plurality of interpolated pixels for a video block in the first frame before generating the at least one set of projections for a video block in the first frame.

15. The apparatus of claim 1, wherein the second projection generator is further configured to accept a plurality of interpolated pixels for a video block in the second frame before generating the at least one set of projections for a video block in the second frame.

16. The apparatus of claim 1, further comprising an interpolator for interpolating the at least one set of projections generated by the first projection generator for a video block in the first frame.

17. The apparatus of claim 1, further comprising an interpolator for interpolating the at least one set of projections generated by the second projection generator for a video block in the second frame.

18. A method of processing video blocks comprising:
generating at least one set of projections for a video block in a first frame;
generating at least one set of projections for a video block in a second frame;
comparing the at least one set projections from a first frame with the at least one set of projections from the second frame; and
producing at least one projection correlation error (PCE) value as a result of the comparison.

19. The method of claim 18, wherein the producing further comprises utilizing one minimum PCE value to generate at least one block motion vector.

20. The method of claim 19, wherein the producing further comprises utilizing the at least one block motion vector to generate a global motion vector for video stabilization.

21. The method of claim 19, wherein the producing further comprises utilizing the at least one block motion vector for video encoding.

22. The method of claim 18, wherein the comparing further comprises taking a first set of the at least one set of projections for a video block in the first frame and shift aligning them with a different set of the at least one set of projections for a video block in the second frame.

23. The method of claim 22, wherein the first set of projections and the different set of projections comprise horizontal projections.

24. The method of claim 22, wherein the first set of projections and the different set of projections comprise vertical projections.

26. The method of claim 22, wherein the first set of projections is a projection vector and the different set of projections is a different projection vector.

27. The method of claim 22, wherein the comparing further comprises performing a subtraction operation between the projection vector and the different projection vector to generate a PCE vector.

28. The method of claim 27, wherein a norm of the PCE vector is taken to generate a PCE value.

29. The method of claim 28, wherein the norm is an L1 norm.

30. The method of claim 18, wherein the comparing further comprises using the following equations given by:
$${PCE}_{+}^{x} ( {Δ}_{y} ) = {\sum }_{y = 0}^{N - {Δ}_{y} - 1} \vert {p}_{i}^{x} ( y ) - {p}_{i - m}^{x} ( {Δ}_{y} + y ) \vert$$
to capture movements in the positive y (vertical) direction;
$${PCE}_{+}^{y} ( {Δ}_{x} ) = {\sum }_{x = 0}^{M - {Δ}_{x} - 1} \vert {p}_{i}^{y} ( x ) - {p}_{i - m}^{y} ( {Δ}_{x} + x ) \vert$$
to capture movements in the positive x (horizontal) direction;
$${PCE}_{-}^{x} ( {Δ}_{y} ) = {\sum }_{y = 0}^{N - {Δ}_{y} - 1} \vert {p}_{i}^{x} ( {Δ}_{y} + y ) - {p}_{i - m}^{x} ( y ) \vert$$
to capture movements in the negative y (vertical) direction;
$${PCE}_{-}^{y} ( {Δ}_{x} ) = {\sum }_{x = 0}^{M - {Δ}_{x} - 1} \vert {p}_{i}^{y} ( {Δ}_{x} + x ) - {p}_{i - m}^{y} ( x ) \vert$$
to capture movements in the negative x (horizontal) direction;
where M is at most the maximum number of columns in a video block;
where Δₓ is a shift position between a vertical projection in frame i and frame i−m;
where N is at most the maximum number of rows in a video block
where Δ_{y} is a shift position between a horizontal projection in frame i and frame i−m; and
where i−m is replaced by i+m if comparing a current frame to a future frame.

31. The method of claim 18, further comprising interpolating a plurality of pixels for a video block in the first frame before generating the at least one set of projections in the first frame.

32. The method of claim 18, further comprising interpolating a plurality of pixels for a video block in the second frame before generating the at least one set of projections in the second frame.

33. The method of claim 18, further comprising interpolating the at least one set of projections for a video block in the first frame.

34. The method of claim 18, further comprising interpolating the at least one set of projections for a video block in the second frame.

35. A computer-readable medium configured to process video blocks, comprising:
computer-readable program code means for generating at least one set of projections for a video block in a first frame;
computer-readable program code means for generating at least one set of projections for a video block in a second frame;
computer-readable program code means for comparing the at least one set projections from the first frame with the at least one set of projections from the second frame; and
computer-readable program code means for producing at least one minimum projection correlation error (PCE) value as a result of the comparison.

36. The computer-readable medium of claim 35, wherein the computer-readable program code means for producing further comprises a computer-readable program code means for utilizing the at least one minimum PCE value for generating at least one block motion vector.

37. The computer-readable medium of claim 36, wherein the computer-readable program code means for producing further comprises a computer-readable program code means for utilizing at least one block motion vector to generate a global motion vector for video stabilization.

38. The computer-readable medium of claim 36, wherein the computer-readable program code means for producing further comprises a computer-readable program code means for utilizing at least one block motion vector for video encoding.

39. The computer-readable medium of claim 35, wherein the computer-readable program code means for comparing further comprises a computer-readable program code means for taking a first set of the at least one set of projections for a video block in the first frame and shift aligning them with a different first set of the at least one set of projections for a video block in the second frame.

40. The computer-readable medium of claim 39, wherein the first set of projections and the different set of projections comprise horizontal projections.

41. The computer-readable medium of claim 39, wherein the first set of projections and the different set of projections comprise vertical projections.

42. The computer-readable medium of claim 39, wherein the first set of projections is a projection vector and the different set of projections is a different projection vector.

43. The computer-readable medium of claim 39, wherein the computer-readable program code means for comparing further comprises a computer-readable program code means for performing a subtraction operation between the projection vector and the different projection vector to generate a PCE vector.

44. The computer-readable medium of claim 43, wherein a norm of the PCE vector is taken to generate a PCE value.

45. The computer-readable medium of claim 44, wherein the norm is an L1 norm.

46. The computer-readable medium of claim 35, wherein the computer-readable program code means for comparing further comprises a computer-readable program code means for using the following equations given by:
$${PCE}_{+}^{x} ( {Δ}_{y} ) = {\sum }_{y = 0}^{N - {Δ}_{y} - 1} \vert {p}_{i}^{x} ( y ) - {p}_{i - m}^{x} ( {Δ}_{y} + y ) \vert$$
to capture movements in a positive y (vertical) direction;
$${PCE}_{+}^{y} ( {Δ}_{x} ) = {\sum }_{x = 0}^{M - {Δ}_{x} - 1} \vert {p}_{i}^{y} ( x ) - {p}_{i - m}^{y} ( {Δ}_{x} + x ) \vert$$
to capture movements in a positive x (horizontal) direction;
$${PCE}_{-}^{x} ( {Δ}_{y} ) = {\sum }_{y = 0}^{N - {Δ}_{y} - 1} \vert {p}_{i}^{x} ( {Δ}_{y} + y ) - {p}_{i - m}^{x} ( y ) \vert$$
to capture movements in a negative y (vertical) direction;
$${PCE}_{-}^{y} ( {Δ}_{x} ) = {\sum }_{x = 0}^{M - {Δ}_{x} - 1} \vert {p}_{i}^{y} ( {Δ}_{x} + x ) - {p}_{i - m}^{y} ( x ) \vert$$
to capture movements in a negative x (horizontal) direction;
where M is at most the maximum number of columns in a video block;
where Δₓ is a shift position between a vertical projection in frame i and frame i−m;
where N is at most the maximum number of rows in a video block;
where 66 _{y} is a shift position between a horizontal projection in frame i and frame i−m; and
where i−m is replaced by i+m if comparing a current frame to a future frame.

47. The computer-readable medium of claim 35, further comprising a computer-readable program code means for interpolating a plurality of pixels for a video block in the first frame before generating the at least one set of projections in the first frame.

48. The computer-readable medium of claim 35, further comprising a computer-readable program code means for interpolating a plurality of pixels for a video block in the first frame before generating the at least one set of projections in the second frame.

49. The computer-readable medium of claim 35, further comprising a computer-readable program code means for interpolating the at least one set of projections for a video block in the first frame.

50. The computer-readable medium of claim 35, further comprising a computer-readable program code means for interpolating the at least one set of projections for a video block in the second frame.

51. An apparatus for processing video blocks, comprising:
means for generating at least one set of projections for a video block in a first frame;
means for generating at least one set of projections for a video block in a second frame;
means for comparing the at least one set projections from the first frame with the at least one set of projections from the second frame; and
means for producing at least one projection correlation error (PCE) value as a result of the comparison.

52. The apparatus of claim 51, wherein the means for producing further comprises a means for utilizing from at least one minimum PCE value for generating at least one block motion vector.

53. The apparatus of claim 52, wherein the means for producing further comprises a means for utilizing the at least one block motion vector to generate a global motion vector for video stabilization.

54. The apparatus of claim 52, wherein the means for producing further comprises utilizing the at least one block motion vector for video encoding.

55. The apparatus of claim 51, wherein the means for comparing further comprises a means for taking a first set of the at least one set of projections for a video block in the first frame and shift aligning them with a different set of the at least one set of projections for a video block in a second frame.

56. The apparatus of claim 55, wherein the first set of projections and the different set of projections comprise horizontal projections.

57. The apparatus of claim 55, wherein the first set of projections and the different set of projections comprise vertical projections.

58. The apparatus of claim 55, wherein the first set of projections is a projection vector and the different set of projections is a different projection vector.

59. The apparatus of claim 55, wherein the means for comparing further comprises a means for performing a subtraction operation between the projection vector and the different projection vector to generate a PCE vector.

60. The apparatus of claim 59, wherein the means for comparing further comprises a means for taking a norm of the PCE vector to generate a PCE value.

61. The apparatus of claim 60, wherein the means for taking the norm further comprises a means for taking an L1 norm.

62. The apparatus of claim 51, wherein the means for comparing further comprises a means for using the following equations given by:
$${PCE}_{+}^{x} ( {Δ}_{y} ) = {\sum }_{y = 0}^{N - {Δ}_{y} - 1} \vert {p}_{i}^{x} ( y ) - {p}_{i - m}^{x} ( {Δ}_{y} + y ) \vert$$
to capture movements in the positive y (vertical) direction;
$${PCE}_{+}^{y} ( {Δ}_{x} ) = {\sum }_{x = 0}^{M - {Δ}_{x} - 1} \vert {p}_{i}^{y} ( x ) - {p}_{i - m}^{y} ( {Δ}_{x} + x ) \vert$$
to capture movements in the positive x (horizontal) direction;
$${PCE}_{-}^{x} ( - {Δ}_{y} ) = {\sum }_{y = 0}^{N - {Δ}_{y} - 1} \vert {p}_{i}^{x} ( {Δ}_{y} + y ) - {p}_{i - m}^{x} ( y ) \vert$$
to capture movements in the negative y (vertical) direction;
$${PCE}_{-}^{y} ( - {Δ}_{x} ) = {\sum }_{x = 0}^{M - {Δ}_{x} - 1} \vert {p}_{i}^{y} ( {Δ}_{x} + x ) - {p}_{i - m}^{y} ( x ) \vert$$
to capture movements in the negative x (horizontal) direction;
where M is at most the maximum number of columns in a video block;
where Δₓ is a shift position between a vertical projection in frame i and frame i−m;
where N is at most the maximum number of rows in a video block;
where Δ_{y} is a shift position between a horizontal projection in frame i and frame i−m; and
where i−m is replaced by i+m if comparing a current frame to a future frame.

63. The apparatus of claim 51, further comprising a means for interpolating a plurality of pixels for a video block in the first frame before generating the at least one set of projections in the first frame.

64. The apparatus of claim 51, further comprising a means for interpolating a plurality of pixels for a video block in the second frame before generating the at least one set of projections in the second frame.

65. The apparatus of claim 51, further comprising a means for interpolating the at least one set of projections for a video block in the first frame.

66. The apparatus of claim 51, further comprising a means for interpolating the at least one set of projections for a video block in the second frame.
